(19) United States
(12) Patent Application Publication
(10) Pub. No.: US 2011/0228283 A1
(43) Pub. Date: Sep. 22, 2011

(54) MEASUREMENT APPARATUS

(75) Inventors: CHIH-KUANG CHANG, Tu-Cheng (TW); SEN ZHANG, Shenzhen City (CN); JIN-KUI ZENG, Shenzhen City (CN)

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/876,250

(22) Filed: Sep. 7, 2010

(30) Foreign Application Priority Data
Mar. 22, 2010 (CN) 201010129316.2

(51) Int. Cl. G01B 11/00

(52) U.S. Cl. 356/601

(57) ABSTRACT

A measurement apparatus includes an observation unit, a movable base, a platform, a pair of tracks mounted on two sides of the platform, and a console. The observation unit is slidably mounted on the movable base. The movable base is a bridge structure. Each end of the movable base is slidably mounted on each one of the pair of tracks. The movable base slides on the pair of tracks along an X-axis of the platform. The observation unit slides on the movable base along a Y-axis of the platform. The observation unit includes a camera. The camera is moveable relative to the observation unit along a Z-axis of the platform.

### BACKGROUND

1. Technical Field

The present disclosure relates to a measurement apparatus for measuring an object.

2. Description of Related Art

An image measurement apparatus is often applied to measuring workpieces. The image measurement apparatus includes a base, a console, a platform, a display device, and a computer. However, the base, the console, the platform, the display device, and the computer are usually in fixed positions, so the image measurement apparatus is not as flexible as desired for the workpieces of different sizes.

### BRIEF DESCRIPTION OF THE DRAWINGS

FIG. 1 is a perspective view of one embodiment of a measurement apparatus.

FIG. 2 is a front view of the measurement apparatus of FIG. 1.

FIG. 3 is a rear view of the measurement apparatus of FIG. 1.

FIG. 4 is a top view of the measurement apparatus of FIG. 1.

### DETAILED DESCRIPTION

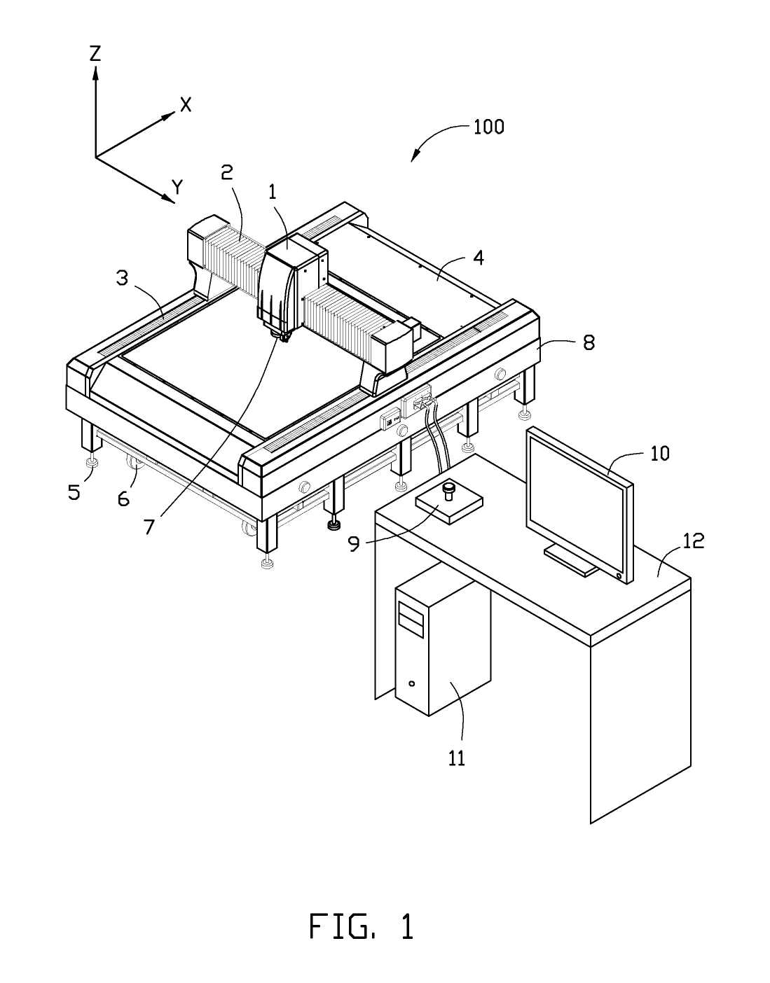

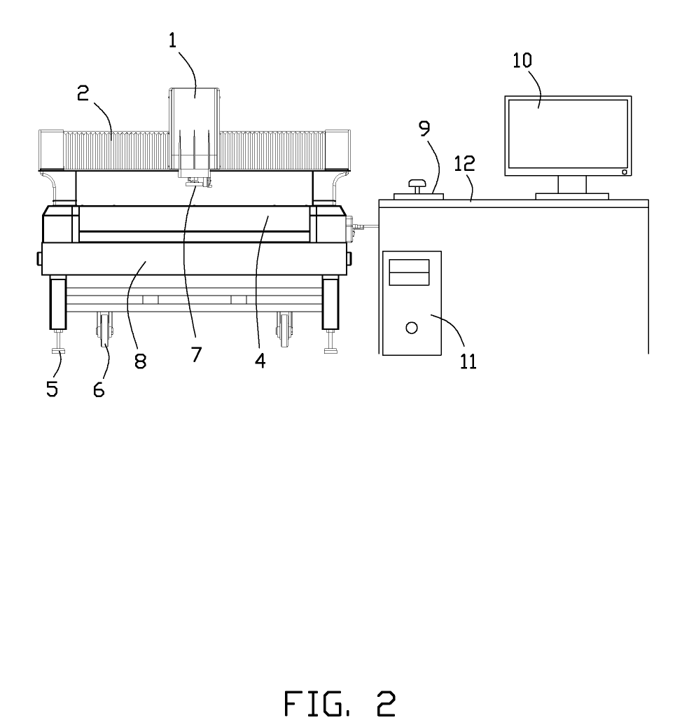

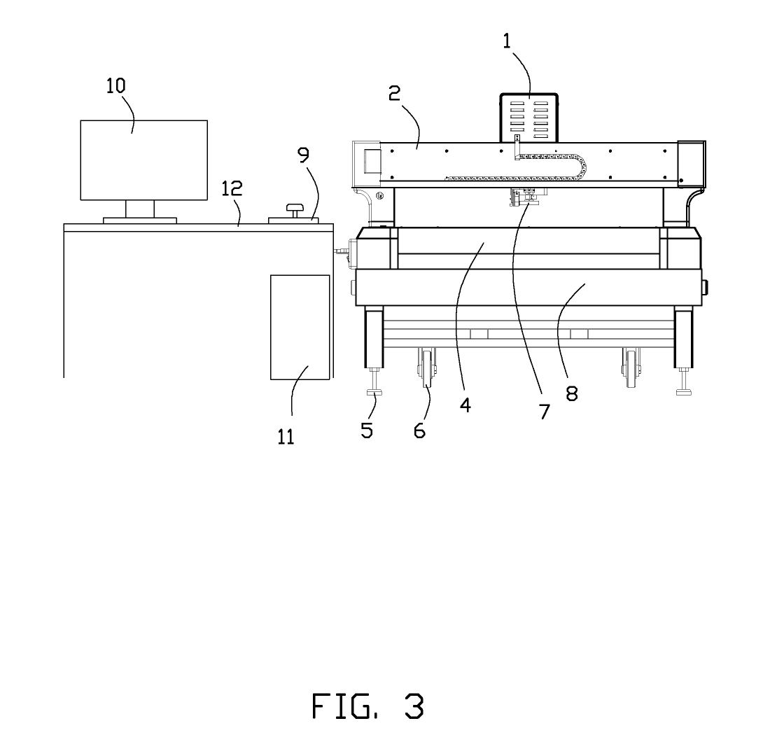

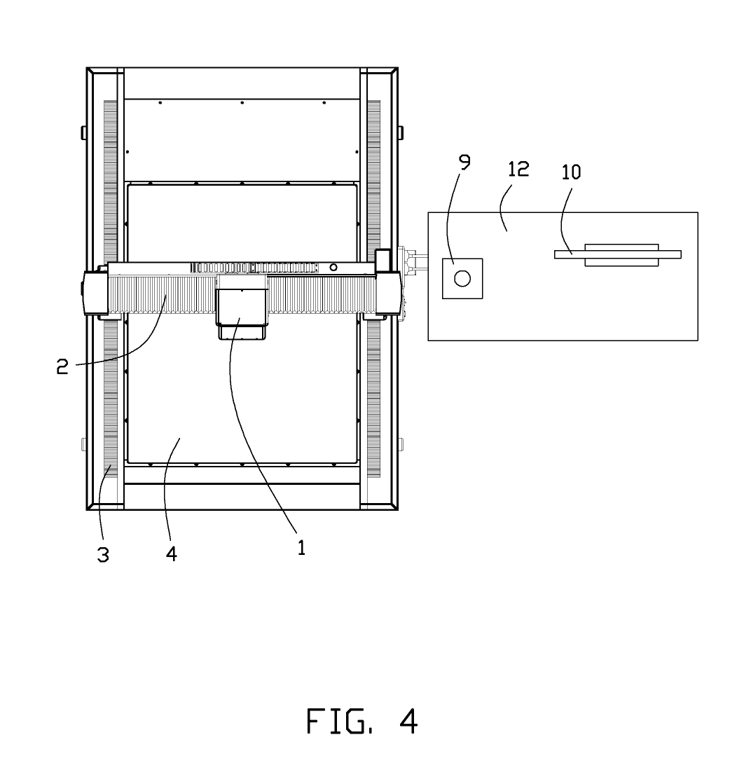

The measurement apparatus 100 can be used to measure dimensions of an object. The object may be a workpiece, an electronic component, or a mechanical component, for example. Referring to FIGS. 1-4, the measurement apparatus 100 includes an observation unit 1, a movable base 2, a platform 4, a pair of tracks 3 mounted on two sides of the platform 4, and a console 8. The observation unit 1 is slidably mounted on the movable base 2. The movable base 2 is a bridge structure. Each end of the movable base 2 is slidably mounted on each one of the pair of tracks 3.

The platform 4 is configured to receive the object and securely mounted on the console 8. The pair of tracks 3 is parallel to an X-axis of the platform 4, so the movable base 2 slides on the pair of tracks 3 along the X-axis of the platform 4. In the embodiment, the maximum stroke of sliding on the pair of tracks 3 of the movable base 2 is approximately 1200 mm. The longitudinal axis of the movable base 2 is parallel to a Y-axis of the platform 4, so the observation unit 1 slides on the movable base 2 along the Y-axis of the platform 4. In the embodiment, the maximum stroke of sliding on the movable base 2 of the observation unit 1 is approximately 1500 mm. The observation unit 1 includes a camera 7 movably installed under the observation unit 1. The camera 7 is movable relative to the observation unit 1 along a Z-axis of the platform 4 to be near or away from the object. In the embodiment, the maximum stroke of movement of the camera 7 relative to the observation unit 1 is approximately 300 mm.

The measurement apparatus 100 further electronically connects with a working table 12. A computer 11 is located under the working table 12. A control handle 9 is installed on the working table 12. The console 8 is in communication with the computer 11 and the working table 12 through cables. The camera 7 further electronically connects with the observation unit 1. The observation unit 1 further electronically connects with the movable base 2. The movable base 2 further electronically connects with the console 8 through the platform 4. As a result, operation of the control handle 9 transmits instructions to the console 8 to move the movable base 2, the observation unit 1, and the camera 7. A display device 10 is located on the working table 12. The display device 10 is in communication with the computer 11 and capable of displaying an operating interface. A mouse and a keyboard (not shown) system may also be employed.

The platform 4 further seats at least three raster scales (not shown) operable to measure location data of the observation unit 1, the movable base 2, and the camera 7 for the computer 11. As a result, the computer may calculate precise movements of the observation unit 1, the movable base 2, and the camera 7.

The measurement apparatus 100 further includes at least one support 5 and at least one moving element 6 mounted under the console 8. The at least one support 5 is operable to support the measurement apparatus 100 and the at least one moving element 6 is operable to move the measurement apparatus 100. In the embodiment, the at least one moving element 6 is a wheel. The at least one support 5 is a telescopic mechanism which may be lengthened and shortened. The at least one moving element 6 is away from the ground when the support 5 is lengthened, such that the measurement apparatus 100 may be fixed on the ground. The at least one moving element 6 contacts the ground when the at least one support 5 is shortened, such that the measurement apparatus 100 may be moveable.

The present disclosure provides a measurement apparatus which may move an observation unit thereof to a desired location to observe an object.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A measurement apparatus, comprising:
a platform capable of supporting an object;
a pair of tracks mounted on two sides of the platform;
a movable base mounted on the pair of tracks;
an observation unit mounted on the movable base operable to observe the object; and
a console upon which the platform is mounted;
wherein the movable base is operable to slide on the pair of tracks and the observation unit is operable to slide on the movable base.

2. The measurement apparatus of claim 1, wherein the observation unit further comprises a camera moveable relative to the observation unit along a Z-axis of the platform.

3. The measurement apparatus of claim 1, wherein the pair of tracks is parallel to an X-axis of the platform, the movable base slides on the pair of tracks along the X-axis of the platform.

4. The measurement apparatus of claim 1, wherein the observation unit slides on the movable base along a Y-axis of the platform.

5. The measurement apparatus of claim 1, wherein the console further electronically connects a working table comprising a control handle operable to operate the movable base, the observation unit, and the camera.

6. The measurement apparatus of claim 3, wherein the platform further comprises at least three raster scales operable to measure location data of the observation unit, the movable base, and the camera.

7. The measurement apparatus of claim 3, further comprising at least one moving element operable to move the measurement apparatus.

8. The measurement apparatus of claim 3, further comprising at least one support operable to support the measurement apparatus.

9. The measurement apparatus of claim 8, wherein the at least one support is a telescopic mechanism.
